(19) United States
(12) Patent Application Publication
(10) Pub. No.: US 2007/0117080 A1
(43) Pub. Date: May 24, 2007

(54) Auxiliary operation system of handheld electronic device

(75) Inventor: Chen-Ning Hsi, Taipei (TW)

Correspondence Address: MADSON & AUSTIN;GATEWAY TOWER WEST, SUITE 900, 15 WEST SOUTH TEMPLE, SALT LAKE CITY, UT, 84101, US

(73) Assignee: Primax Electronics Ltd.

(21) Appl. No.: 11/391,423

(22) Filed: Mar. 28, 2006

(30) Foreign Application Priority Data
Nov. 18, 2005 (TW) 094140681

(51) Int. Cl. G09B 5/04

(52) U.S. Cl. 434/319

(57) ABSTRACT

A handheld electronic device having an auxiliary operation system is provided. The auxiliary operation system may facilitate a user to operate a handheld electronic device according to guidance of audio cues.

### FIELD OF THE INVENTION

The present invention relates to an auxiliary operation system, and more particularly to an auxiliary operation system for facilitating a user to operate a handheld electronic device by hearing the audio cue.

### BACKGROUND OF THE INVENTION

Generally, when a handheld electronic device such as a mobile phone, a personal digital assistant (PDA) or a digital Walkman is used, the user needs look at the screen for realizing or controlling the operation of the handheld electronic device. In other words, following the instructions shown on the screen, the user can navigate functions of the handheld electronic device with the help of vision. As known, the sense of sight for the user may be hindered in some circumstances. For example, in the case of driving while using the mobile phone, the user fails to fix his eyes on the screen because of the likelihood of the traffic accident. In addition, if the handheld electronic device is used in a dark environment or a small-size screen is employed, the information shown on the screen is not clearly visible. Meanwhile, other sensory organs of the user need function well to facilitate the user to operate the handheld electronic device. Therefore, efforts are exerted on making use of the sensory organs other than the sense of sight to facilitate the user to operate the handheld electronic device.

For a purpose of increasing convenience, the mobile phone has some other extended uses such as a voice dialing function. By means of the voice dialing function, the mobile phone may dial the number of the receiver when the user speaks toward the mobile phone without the need of fixing his eyes on the screen and pushing the phone number. Such a voice dialing function is not satisfactory due to some drawbacks. For example, a voice recognition program is necessary to recognize the voice command issued by the user. In other words, even when a simple dialing action is executed, a series of complicated voice recognition tasks are inevitable. Therefore, there is a need of developing a suitable auxiliary operation system for facilitating a user to operate the handheld electronic device.

Typically, following the instructions shown on the screen, the user can navigate functions of the handheld electronic device by moving the cursor to the desired operation item on a step-by-step basis. For example, by pressing the up/down buttons, the selective item shown on the function menu is moved to the next one. For a purpose of moving to the desired selective item, the up/down buttons should be repeatedly pressed down. This operation system is not user-friendly and thus the user needs look at the screen for realizing or controlling the operation of the handheld electronic device.

In views of the above-described disadvantages of the prior art, the applicant keeps on carving unflaggingly to develop an auxiliary operation system for facilitating a user to operate a handheld electronic device according to the present invention through wholehearted experience and research.

### SUMMARY OF THE INVENTION

As previously described, since the conventional handheld electronic device lacks a simple and effective auxiliary operation system, the user fails to successfully execute the desired function because the sense of sight for the user may be hindered in some circumstances.

It is an object of the present invention to provide an auxiliary operation system for facilitating a user to operate a handheld electronic device so as to avoid repeatedly inputting instructions.

It is another object of the present invention to provide a handheld electronic device having an auxiliary operation system for generating an audio cue to help the user well understand what he can do.

In accordance with an aspect of the present invention, there is provided a menu-browsing method for use in a handheld electronic device. The menu includes a plurality of selective items. Firstly, a menu-browsing instruction is received. In response to the menu-browsing instruction, audio files corresponding to the selective items of the menu are read. Afterwards, the audio files are successively and orderly outputted one by one.

In accordance with another aspect of the present invention, there is provided an auxiliary operation system of a handheld electronic device for facilitating a user to browse plural selective items of a menu. The handheld electronic device includes an audio output unit and an instruction input unit. The auxiliary operation system of the handheld electronic device comprises an audio database and an audio reproducing program. The audio database including audio files corresponding to the plural selective items of the menu. In response to a menu-browsing instruction issued from the instruction input unit, the audio reproducing program controls the audio output unit to successively and orderly output the audio files one by one.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1 is a schematic functional block diagram illustrating a handheld electronic device having an auxiliary operation system according to a preferred embodiment of the present invention; and

FIGS. 2A˜2K are schematic diagrams illustrating a mobile phone using the auxiliary operation system for guiding the user to control the mobile phone to execute certain functions.

### DETAILED DESCRIPTION OF THE PREFERRED EMBODIMENT

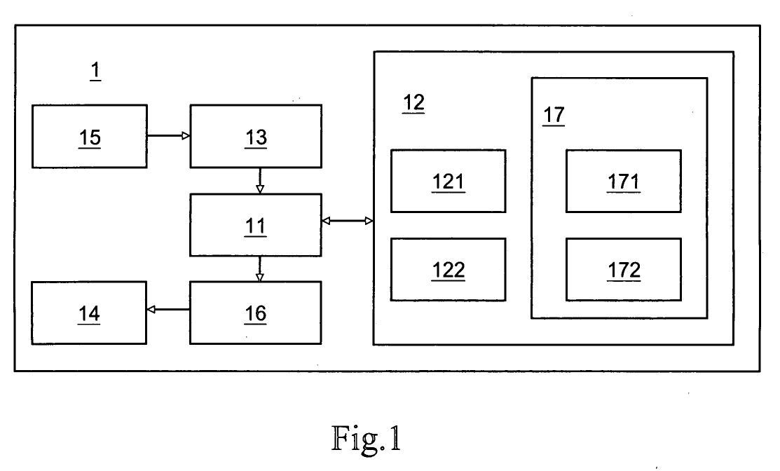

Referring to FIG. 1, a schematic functional block diagram of a handheld electronic device having an auxiliary operation system according to a preferred embodiment of the present invention is shown. The handheld electronic device 1 comprises a processor 11, a memory 12, a digital-to-analog converter (DAC) 16, an audio output unit 14, an instruction input unit 15, an analog-to-digital converter (ADC) 13 and an auxiliary operation system 17. The programs previously stored in the memory 12 may be executed by the processor 11 to perform data computation and control operations. An exemplary memory 12 used in the handheld electronic device 1 includes for example a read-only memory (ROM), a random-access memory (DRAM) or a combo-memory.

The instruction input unit 15 of the handheld electronic device 1 is built as an internal or external part of the handheld electronic device 1. An exemplary instruction input unit 15 includes an analog-to-digital element such as a button, a rotary wheel (or a rotary disc), a touch screen or a microphone. In response to a user's actions, an electronic signal is issued from the instruction input unit 15 to the analog-to-digital converter 13 to be converted into a digital signal. The digital signal is processed by the processor 11 to perform associate data computation and control operations. In an embodiment, the user's action includes for example a pressing action, a stirring action, a touching action or the generation of sound.

Please refer to FIG. 1 again. The auxiliary operation system 17 of the handheld electronic device 1 may help the user clearly understand what procedure is proceeding and how to make selection. As a consequence, the handheld electronic device 1 can be used in the situation when the user is situated in a dark environment, when the information shown on the screen is not clearly visible due to a small-size screen or when the user use the handheld electronic device 1 in the case of driving. According to the guidance or cue of the auxiliary operation system 17, the user can make his selection through the function menu. In an embodiment, an audio database 171 and an audio reproducing program 172 has been stored in the memory 12 of the auxiliary operation system 17. The audio database 171 includes several preset audio files corresponding to certain selective items of the function menu. In response to an instruction issued from the instruction input unit 15, the audio reproducing program 172 will read an audio file corresponding to a specified selective item from the audio database 171. The digital data of the audio file are converted into analog signals by the digital-to-analog converter 16. Via the audio output unit 14, the audio files are successively outputted one by one. Under this circumstance, the user can recognize which item is located without repeatedly operating the instruction input unit 15. When the desired selective item is located, the user may operate the instruction input unit again to browse the sub-items or execute the selected function.

As previously described, under control of the audio reproducing program 172, the audio files are successively and orderly outputted one by one via audio output unit 14. It is preferred that the next audio file will be outputted after the current audio file is outputted for a preset time interval such as several seconds. Accordingly, the preset time interval may help the user understand what procedure is proceeding and then make desired selection. Moreover, the audio files that are playing in a certain sequence may be automatically or manually stopped. For example, according to a programmed schedule, the handheld electronic device 1 stops playing the audio files that are playing after two or three cycles of playing the audio files, thereby automatically pausing operation of the auxiliary operation system 17. Alternatively, in response to an escape or pause instruction inputted by the user, the operation of the auxiliary operation system 17 of the handheld electronic device 1 is interrupted.

In the handheld electronic device 1 of the present invention, the audio files corresponding to certain selective items of the function menu are directly built in the audio database 171. In addition, by means of the instruction input unit 15 and a ring tone editor program 121 stored in the memory 12, the user may edit the ring tones corresponding to the selective items of the function menu, and the edited ring tones are saved as audio files in the audio database 171. Alternatively, by means of the instruction input unit 15 and a sound recording program 122 stored in the memory 12, the sound received by the microphone and emitted by the user may be saved as audio files corresponding to certain selective items of the function menu, and the audio files are then stored in the audio database 171.

The auxiliary operation system 17 may help the user understand what procedure is proceeding and then make desired selection. The audio files corresponding to certain selective items of the function menu are distinguished by the uniqueness in pitch, amplitude, timbre or duration, so that the user may recognize what selective item is located and what procedure is proceeding. Moreover, the audio files to be recorded by the user include the name list in the address book, the browse folder dialog or other plentiful of complicated items. That is to say, in addition to the general items of the function menu, the items in this embodiment include the name lists in the address book, the text contents of the short messages, the selective items for function settings or the folder names.

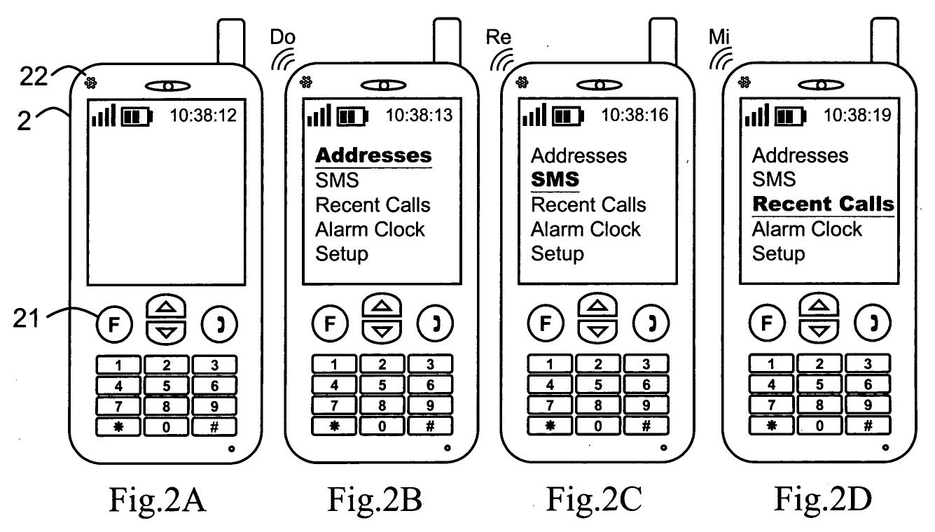

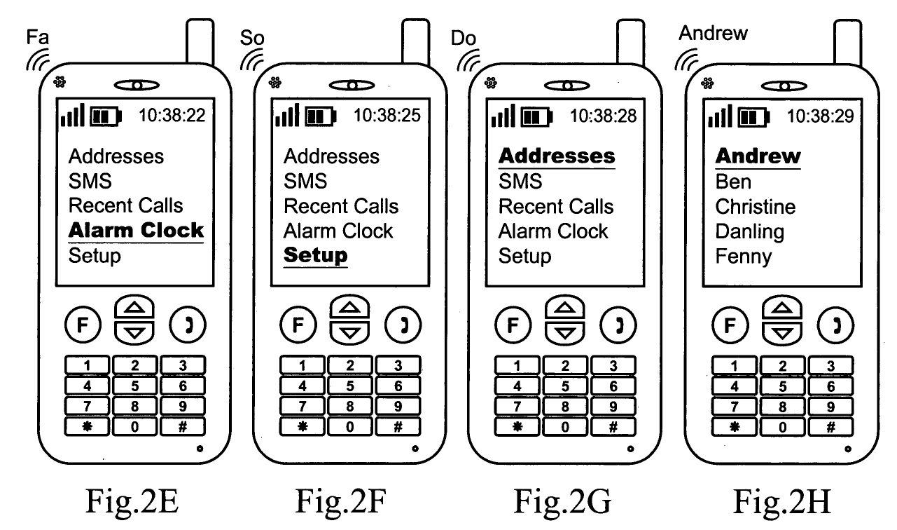

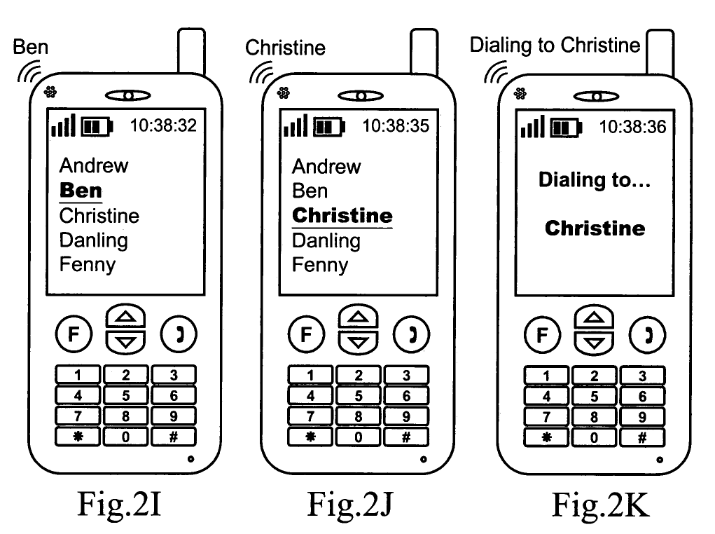

Hereinafter, an embodiment of an auxiliary operation system and the operation of the auxiliary operation system for facilitating a user to operate the handheld electronic device according to the present invention will be illustrated with reference to FIGS. 2A˜2K. The handheld electronic device of this embodiment is a mobile phone 2.

There are a plurality of selective items, e.g. address book, short message service (SMS), recent calls, alarm clock and setup, included in the function menu of the mobile phone 2. The user may have been previously edited five monosyllables distinguishable in pitches, for example Do, Re, Mi, Fa and So, as audio files to be stored in the audio database 171. Subsequently, these selective items, i.e. addresses, short message service (SMS), recent calls, alarm clock and setup, are set to correlate with the five monosyllables Do, Re, Mi, Fa and So, respectively. As shown in FIG. 2A, if the user is intended to browse the function menu of the mobile phone 2, when a menu-browsing instruction is inputted via the instruction input unit, for example upon the access key 21 (F key) is once pressed down, the audio reproducing program will read the audio files corresponding to the selective items from the audio database. Meanwhile, as shown in FIGS. 2B˜2G, the five monosyllables Do, Re, Mi, Fa and So are successively, orderly and cyclically outputted one by one via the audio output unit 22. Under this circumstances, the user may realize what items are browsed upon the corresponding monosyllables are heard or have been terminated for a certain time period. Meanwhile, when a desired selective item is located before the next audio file is outputted, the user may input an item-selection instruction via the instruction input unit, for example presses down the access key 21 (F key) again, thereby making his selection about this selective item.

After the selective item is entered, the audio files corresponding to the sub-items or second layer items of this selective item are successively, orderly and cyclically outputted one by one via the audio output unit 22. Similarly, these audio files corresponding to certain sub-items or second layer items of this selective item are distinguished by the uniqueness in pitch, amplitude, timbre or duration. Moreover, the audio files corresponding to certain sub-items or second layer items of this selective item may be directly outputted via the audio output unit 22. As shown in FIGS. 2G˜2J, if the selective item “Addresses” is selected, the name lists in the address book of the mobile phone 2, i.e. the sub-items or second layer items of this selective item, will be successively, orderly and cyclically outputted one by one via the audio output unit 22. Under this circumstances, the user may realize what name list is browsed upon the corresponding audio file is outputted or has been terminated for a certain time period. Meanwhile, when a desired name is located, the user may input a dialing instruction via the instruction input unit, for example presses down the access key 21 (F key) again, thereby dialing to the selected name of the receiver, as is seen in FIG. 2K. As a consequence, according to the sense of hearing, the user can browse the name lists in the address book of the mobile phone without fixing his eyes on the screen.

It is noted that, however, those skilled in the art will readily observe that numerous modifications and alterations of the instruction input unit may be made while retaining the teachings of the invention. For example, in replace of the access key 21, the instruction input unit can be a button, a rotary wheel, a rotary disc, a touch screen or a microphone. Accordingly, the above disclosure should be limited only by the bounds of the following claims.

The handheld electronic device of present invention is illustrated by referring to a mobile phone with an auxiliary operation system. Nevertheless, the handheld electronic device of present invention can have a built-in digital Walkman such as an MP3 player or the digital Walkman per se. In a case that a plurality of songbooks or folders have been stored the digital Walkman, the user may browse the songbooks after the menu-browsing instruction is inputted via the instruction input unit 15 as shown in FIG. 1. Meanwhile the audio reproducing program 172 will read the audio files corresponding to the names of the songbooks from the audio database 171 and then these audio files will be successively, orderly and cyclically outputted one by one via the audio output unit 14. As a consequence, according to the sense of hearing, the user can browse the names of the songbooks in the digital Walkman without fixing his eyes on the screen. Meanwhile, when a desired name is located, the user may input a song playing instruction via the instruction input unit 15, thereby playing the selected song or music of the songbooks. Moreover, in addition to browsing the selective items of the same layer items, the auxiliary operation system of the handheld electronic device of the present invention may facilitate the user to browse sub-items in the multilevel hierarchy. For example, the songbooks with different song types may be included in different folders of the digital Walkman. Under this circumstance, after the menu-browsing instruction is inputted via the instruction input unit 15, the audio files corresponding to the names of the folders will be successively, orderly and cyclically outputted one by one via the audio output unit 14. Meanwhile, after a desired folder is located, the instruction input unit 15 may be actuated again, and thus the audio files corresponding to the songbooks included in the selected folder will be successively, orderly and cyclically outputted one by one via the audio output unit 14. Subsequently, after a desired name in the songbook is located, the user may input a song playing instruction via the instruction input unit 15, thereby playing the selected song or music in the songbook.

The process for browsing the function menu of the handheld electronic device according to a preferred embodiment of the present invention includes the steps of receiving a menu-browsing instruction; reading the audio files corresponding to the selective items of the function menu from the audio database of the memory; and successively and orderly outputting the audio files one by one. The instruction input unit of the present invention is built as an internal or external part of the handheld electronic device, so that the user may input the menu-browsing instruction there via. In response to the menu-browsing instruction, the audio reproducing program stored in the memory of the handheld electronic device will read the audio files corresponding to selective items from the audio database of the memory, and then the audio files are successively and orderly outputted one by one via the audio output unit.

From the above embodiments, in response to the menu-browsing instruction, the auxiliary operation system of the present invention may automatically output the audio files corresponding to the selective items until the operation of the auxiliary operation system is terminated or the user escapes from the auxiliary operation system. In addition, via the auxiliary operation system, the user can set different audio cues depending on the uniqueness in pitch, amplitude, timbre or duration, so that the user may recognize what selective item is located and what procedure is proceeding. Moreover, the audio files recorded by the user may help the user clearly understand what procedure is proceeding and how to make selection.

The auxiliary operation system of the handheld electronic device provided by the present invention may facilitate the user to browse all selective items in the function menu when the corresponding audio files are outputted. In addition, the auxiliary operation system may facilitate the user to browse some selective items according to the user's requirement so as to increase the browsing speed. For example, in the case of driving while using the mobile phone to dial an urgent call, only the audio files corresponding to the name lists of some important persons (e.g. the family or the fellow workers) in the address book are successively and orderly outputted one by one. Under this circumstance, the user may rapidly browse the name lists in the address book and then make selection to dial a desired phone number.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A menu-browsing method for use in a handheld electronic device, said menu including a plurality of selective items, said method comprising steps of:
receiving a menu-browsing instruction;
reading audio files corresponding to said selective items of said menu in response to said menu-browsing instruction; and
successively and orderly outputting said audio files one by one.

2. The menu-browsing method for use in a handheld electronic device according to claim 1 wherein said audio files are distinguished by the uniqueness in pitch.

3. The menu-browsing method for use in a handheld electronic device according to claim 1 wherein said audio files are distinguished by the uniqueness in amplitude.

4. The menu-browsing method for use in a handheld electronic device according to claim 1 wherein said audio files are distinguished by the uniqueness in timbre.

5. The menu-browsing method for use in a handheld electronic device according to claim 1 wherein said audio files are distinguished by the uniqueness in duration.

6. The menu-browsing method for use in a handheld electronic device according to claim 1 wherein said handheld electronic device is a mobile phone, and said menu is a built-in function menu of said mobile phone.

7. The menu-browsing method for use in a handheld electronic device according to claim 1 wherein said handheld electronic device is a mobile phone, said menu is an address book of said mobile phone, and said items are name lists included in said address book.

8. The menu-browsing method for use in a handheld electronic device according to claim 1 wherein said handheld electronic device is a digital Walkman, and said items are names of songbooks stored in said digital Walkman.

9. An auxiliary operation system of a handheld electronic device for facilitating a user to browse plural selective items of a menu, said handheld electronic device including an audio output unit and an instruction input unit, said auxiliary operation system of said handheld electronic device comprising:
an audio database including audio files corresponding to said plural selective items of said menu; and
an audio reproducing program for controlling said audio output unit to successively and orderly output said audio files one by one in response to a menu-browsing instruction issued from said instruction input unit.

10. The auxiliary operation system of a handheld electronic device according to claim 9 wherein said handheld electronic device is a mobile phone, and said menu is a built-in function menu of said mobile phone.

11. The auxiliary operation system of a handheld electronic device according to claim 9 wherein said handheld electronic device is a mobile phone, said menu is an address book of said mobile phone, and said items are name lists included in said address book.

12. The auxiliary operation system of a handheld electronic device according to claim 9 wherein said handheld electronic device is a digital Walkman, and said items are names of songbooks stored in said digital Walkman.

13. The auxiliary operation system of a handheld electronic device according to claim 9 further comprising a sound recording program for recording the sound emitted by said user as audio files.
